(19) United States
(12) Patent Application Publication
(10) Pub. No.: US 2018/0213825 A1
(43) Pub. Date: Aug. 2, 2018

(54) METHOD FOR MANUFACTURING PRODUCT FILLED WITH HYDROGEN WATER

(71) Applicant: NIKKO SEISAKUSHO CO., LTD., Shizuoka (JP)

(72) Inventors: Junichi SUGIYAMA, Numazu-shi (JP); Toshimi KOBAYASHI, Numazu-shi (JP); Masato KOBAYASHI, Numazu-shi (JP)

(21) Appl. No.: 15/632,795

(22) Filed: Jun. 26, 2017

(30) Foreign Application Priority Data
Jan. 31, 2017 (JP) 2017-015658

(51) Int. Cl. A23L 2/54; A23L 2/44; A23L 3/3436; C02F 1/461; B01F 3/04

(52) U.S. Cl. CPC A23L 2/54; A23L 2/44; C02F 2103/026; C02F 1/4618; B01F 3/04099; A23L 3/3436

(57) ABSTRACT

A method of manufacturing a product filled with hydrogen water, the method including filling a can container with hydrogen water, and sealing a can lid section onto a can trunk section, wherein the hydrogen water is filled and sealed in a state in contact with an inner surface of a can body, primary overflow overflows the hydrogen water from the can container in a process of filling the can container with the hydrogen water and secondary overflow overflows the hydrogen water from the can body in a process of attaching the can lid section to the can container are performed, and in the process of attaching the can lid section to the can container, the hydrogen water is pushed into the can container while a predetermined pressure is applied to the can lid section while the secondary overflow state is maintained and sealing of the can lid section is performed.

### CROSS-REFERENCE TO RELATED APPLICATION

Priority is claimed on Japanese Patent Application No. 2017-015658, filed Jan. 31, 2017, the content of which is incorporated herein by reference.

### BACKGROUND

### Field of the Invention

The present invention relates to a method for manufacturing a product filled with hydrogen water.

### Description of Related Art

Since it was recognized that hydrogen water is effective for maintaining health, production and sales of hydrogen water have been attracting attention. The reason for this is the involvement of hydrogen water in eliminating so-called “oxidative stress,” which is related to occurrence and worsening of various diseases. Active oxygen normally generated in a living body plays a role in parts of immune function of the body. However, when more active oxygen than necessary is generated (this state is referred to as “oxidative stress”) the oxidative stress acts as a factor that exerts bad influence on a person. For this reason, it is known that excessive active oxygen should be removed on a daily basis. In addition, though all may be simply called “active oxygen,” the molecular forms are various, and therefore it is known that there is no mechanism configured to uniformly remove all molecular species of active oxygen.

According to recent research results related to mechanisms configured to remove active oxygen, it was proposed that molecular hydrogen is involved in removing some of the molecular species of “active oxygen.” As a result, as a method of easily taking in molecular hydrogen, more people are practicing continuous drinking of hydrogen water. However, functions and effects of molecular hydrogen in living bodies have not been explicated in detail, but are currently undergoing extensive research at various research institutes.

As such interest in hydrogen water increases, various techniques related to hydrogen water production have been developed and improved, and specifically, the following methods can be exemplified.

(1) Electrolysis method

(2) Pressurized dissolving method

(3) Gas-liquid mixing nozzle method

(4) Micro-nano valve method

(5) Gas-liquid separating hollow fiber membrane method

In any of these manufacturing methods, hydrogen water having a saturated concentration at a liquid temperature (for example, a dissolved hydrogen concentration is 1.6 ppm at 25° C.) or a high concentration close to the saturated concentration can be manufactured, and is being sold as a domestic/industrial hydrogen water dispenser or a hydrogen water manufacturing apparatus.

A so-called “water dispenser” has also come into wide use in general homes. According to development of a hydrogen water manufacturing technology, a domestic “hydrogen water dispenser” for beverages is also manufactured and sold by several companies. Domestic “hydrogen water dispensers” have begun to be popularized under the background of growing health consciousness. In the case of a domestic “hydrogen water dispenser,” since the “high concentration hydrogen water” supplied from the server is assumed to be instantly consumed in a timely manner, there are few notices or problems concerning preservation of hydrogen water.

Meanwhile, as a method by which hydrogen water can be easily drunk, “hydrogen water packed in a container in a sealed state” (hereinafter, this is referred to as “packaged hydrogen water”) can also be used, and for this purpose, some types are commercially available. Classifying types of “packaged hydrogen water” that is commercially available, the following three general types are provided:

(1) PET bottle packaging

(2) Aluminum pouch packaging

(3) Aluminum bottle packaging.

However, in any of these types of hydrogen water, large problems about its preservation properties are noted.

That is, cases in which a dissolved hydrogen concentration of hydrogen water, i.e., “packaged hydrogen water,” is remarkably low or hydrogen is not contained in the water may frequently occur at the time of purchase, and problems relating to preservation properties of hydrogen are emerging.

Further, examples of a method of preserving hydrogen water are disclosed in Japanese Unexamined Patent Application, First Publication No. 2009-208067 and Japanese Unexamined Patent Application, First Publication No. 2009-208063. In Japanese Unexamined Patent Application, First Publication No. 2009-208067 and Japanese Unexamined Patent Application, First Publication No. 2009-208063, discharge of hydrogen is suppressed by instant cryopreservation after generating the hydrogen water. However, in such a method, it takes a long time to melt the hydrogen water that has been cryopreserved (for example, about 12 hours at room temperature), and there is a large disadvantage that the hydrogen water cannot be easily drunk immediately when a consumer wants to drink it. In addition, since freezing is required during preservation, manufacturing cost is increased, refrigeration equipment is also required for distribution or preservation and display at each store, and inconveniences in practice such as these have also not been resolved.

### SUMMARY

An aspect of the present invention is directed to providing a method of manufacturing a product filled with hydrogen water capable of suppressing discharge of hydrogen from the hydrogen water.

A method of manufacturing a product filled with hydrogen water according to an aspect of the present invention includes generating hydrogen water in which hydrogen is dissolved by mixing raw water and hydrogen gas, filling a metal can container with the hydrogen water, and then covering a can trunk section of the can container with a can lid section and sealing the can lid section onto the can trunk section, wherein, in a sealed state in which the can lid section is sealed onto the can trunk section, the hydrogen water that is filled in a can body is filled and sealed in a state in which the hydrogen water is not in contact with any gas other than hydrogen and the hydrogen water is in a direct contact with an inner surface of the can body, when the filling and sealing is performed, the can body is filled with the hydrogen water in a full injection state by performing at least both of: a primary overflow that overflows the hydrogen water from the can container in a process of filling the hydrogen water in the can container, and a secondary overflow that overflows the hydrogen water from the can body in a process of attaching the can lid section to the can container filled with the hydrogen water, and in the process of attaching the can lid section to the can container, the hydrogen water is pushed into the can container while a predetermined pressure is applied to the can lid section while the secondary overflow state is maintained and sealing of the can lid section with respect to the can container is performed.

According to the above-mentioned configuration, after manufacturing, discharge of hydrogen from the hydrogen water with which the can is filled and sealed can be suppressed to a remarkably low ratio until a user uses the hydrogen water (for example, drinking when used as a beverage), and the dissolved hydrogen concentration of the hydrogen water during distribution can be maintained at a high level. In addition, since preservation of the product filled with hydrogen water is performed at a normal temperature, it takes no time or effort to thaw the hydrogen water, and a user can drink it immediately when the user wants to drink it. In addition, since it is not cryopreservation, the distribution cost can also be reduced, which means that the equipment burden on the dealer is small and the cost for preservation is also suppressed (for example, refrigeration equipment such as a freezer or the like in storage of a warehouse, a store showcase, or the like). Further, because the stored product is easy to handle for all of manufacturers, distributors, sellers (retailers), users, etc., the convenience, easiness, and the like of the product form is improved.

In addition, because both the primary overflow during the filling with the hydrogen water and the secondary overflow when the can lid section is attached are performed, it is possible to reliably perform the full injection filling of the metal can body with the hydrogen water.

In addition, in the process of attaching the can lid section to the can container, since the hydrogen water is pushed into the can container while a predetermined pressure is applied to the can lid section in the secondary overflow state and sealing of the can lid section with respect to the can container is performed, the can container can be filled with the hydrogen water to the full injection state while the pressure is applied to the generated hydrogen water such that no head space is generated in the can. Accordingly, discharge of the hydrogen from the hydrogen water can be suppressed while the can is filled in the full injection state with the hydrogen water in a supersaturated state.

In addition, in the method of manufacturing the product filled with hydrogen water, in the process of attaching the can lid section to the can container, sealing of the can lid section with respect to the can container may be performed by pushing the hydrogen water into the can container while applying a predetermined pressure to a surface of the can lid section.

According to the above-mentioned configuration, in the process of attaching the can lid section to the can container, since sealing of the can lid section onto the can container is performed by pushing the hydrogen water into the can container while applying the predetermined pressure to the surface of the can lid section, the can lid section can be attached to the can container while pressing the hydrogen water in the supersaturated state on substantially the entire surface of the can lid section. Accordingly, discharge of the hydrogen from the hydrogen water can be further suppressed while the can is filled in the full injection state with the hydrogen water in the supersaturated state.

In addition, in the method of manufacturing the product filled with hydrogen water, in the process of attaching the can lid section to the can container, sealing of the can lid section with respect to the can container may be performed by a double seaming technique of wrapping and pressure bonding a circumferential edge of the can lid section to a flange portion of an upper edge of the can trunk section.

According to the above-mentioned configuration, since sealing of the can lid section onto the can container is performed by a double seaming technique of wrapping and pressure bonding a circumferential edge of the can lid section to a flange portion of an upper edge of the can trunk section, the circumferential edge of the can lid section is reliably pressure-joined and bonded to the upper edge of the can trunk section, and sealing of the can lid section can be performed while no head space is present at an upper section of the can body. Accordingly, the can is filled in the full injection state with the hydrogen water in the supersaturated state, and the hydrogen water can be maintained at a high concentration even after sealing of the can lid section.

In addition, in the method of manufacturing the product filled with hydrogen water, in the process of filling the can container with the hydrogen water, except at the beginning of the filling with the hydrogen water, injection of the hydrogen water may be performed in a submerged state in which an ejection port of a water injecting nozzle is disposed under a water surface of the hydrogen water already injected into the can container.

According to the above-mentioned configuration, when the can container is filled with the hydrogen water, since the water injecting nozzle performs the filling in the submerged state except at the beginning of the filling, it is possible to create a situation in which contact between the hydrogen water and air is minimized as much as possible, and a filling method for suppressing release of hydrogen is obtained. Further, the conclusion that such submerged filling is preferable is based on an experiment (filling speed is constant) performed by the inventor(s) on the difference in the amount of the dissolved hydrogen amount caused by the difference in filling position.

In addition, in the method of manufacturing the product filled with hydrogen water, in the process of filling the can container with the hydrogen water, filling of the hydrogen water may be performed in a state in which a pressure in a filling pipeline is held within a predetermined range by a pressure adjustment mechanism installed in the filling pipeline upstream from the water injecting nozzle in a transferred direction of the hydrogen water.

According to the above-mentioned configuration, in the process of filling the can container with the hydrogen water, since the pressure in the filling pipeline is held within a predetermined range by the pressure adjustment mechanism, the hydrogen water is filled with hydrogen during transport until the pressure in the filling pipeline is increased to the predetermined range by the pressure adjustment mechanism. Accordingly, in comparison with the related art, discharge of the hydrogen from the hydrogen water can be suppressed by filling the hydrogen water with a large amount of hydrogen.

According to the aspect of the present invention, after manufacturing, discharge of hydrogen from the sealed and filled hydrogen water can be suppressed to a remarkably low ratio until a user uses the hydrogen water (for example, drinking when used as a beverage), and the dissolved hydrogen concentration of the hydrogen water during distribution can be maintained at a high level. In addition, since preservation of the product filled with hydrogen water is performed at a normal temperature, it takes no time or effort to thaw the hydrogen water and a user can drink it immediately when the user wants to drink it. In addition, since it is not cryopreservation, the distribution cost can also be reduced, which means that the equipment burden on the dealer is small and the cost for preservation is also suppressed (for example, refrigeration equipment such as a freezer or the like in storage of a warehouse, a store showcase, or the like). Further, because the stored product is easy to handle for all of manufacturers, distributors, sellers (retailers), users, etc., the convenience, easiness, and the like of the product form is improved.

In addition, because both the primary overflow during the filling with the hydrogen water and the secondary overflow when the can lid section is attached are performed, it is possible to reliably perform the full injection filling of the metal can body with the hydrogen water.

In addition, in the process of attaching the can lid section to the can container, since the hydrogen water is pushed into the can container while a predetermined pressure is applied to the can lid section in the secondary overflow state and sealing of the can lid section with respect to the can container is performed, the can container can be filled with the hydrogen water in the full injection state while the pressure is applied to the generated hydrogen water such that no head space is generated in the can. Accordingly, discharge of the hydrogen from the hydrogen water can be suppressed while the can is filled in the full injection state with the hydrogen water in a supersaturated state.

### BRIEF DESCRIPTION OF THE DRAWINGS

FIG. 1 is a view for describing an example of an apparatus for manufacturing a product filled with hydrogen water according to the present invention.

FIG. 2 is a schematic perspective view showing an example of a filled product (a product filled with hydrogen water) according to the present invention, and part (a) and part (b) are perspective views showing states of the inside of the product.

FIG. 3 is a view for stepwisely describing states (a first half) when a can container is filled with hydrogen water.

FIG. 4 is a view for stepwisely describing a final step when the can container is filled with hydrogen water and a state in which a can lid section is attached to the can container filled with the hydrogen water.

FIG. 5 is a graph showing chronological variations over six months of dissolved hydrogen concentrations of products filled with hydrogen water that are already on the market (competitor's products).

FIG. 6 is a graph in which hydrogen water is filled in two containers having different air contact areas are filled with hydrogen water and chronological variations of dissolved hydrogen concentrations in the two containers are compared.

FIG. 7 is a graph showing chronological variations of dissolved hydrogen concentrations when a PET bottle is filled with hydrogen water in a full injection state and when filled with hydrogen water such that a head space is formed.

FIG. 8 is a graph showing the result of storing hydrogen water with which a can body (a steel can) is filled in a full injection state (a filled product according to the present invention) in a thermostatic tank of 37° C., i.e., assuming summer, and measuring dissolved hydrogen concentrations of the hydrogen water every week.

FIG. 9 is a view for describing a pressure adjustment mechanism.

FIG. 10 is a graph showing a variation in hydrogen concentration according to application of the pressure adjustment mechanism.

### DESCRIPTION OF EMBODIMENTS

Hereinafter, an embodiment of the present invention will be described with reference to the accompanying drawings.

Hereinafter, in the following description, reviews and considerations relating to preservation properties of generated hydrogen water will be firstly mentioned.

That is, firstly it is shown from the current situation of a preservation method of “packaged hydrogen water” (corresponding to “a product 10 filled with hydrogen water” of the present invention) and the basic technical feature of the present invention that how can we preserve the hydrogen water under a normal temperature atmosphere to suppress discharge of hydrogen from hydrogen water. Then, after the name of the can body when the product 10 filled with hydrogen water is manufactured or the hydrogen water is described (defined), a manufacturing method will be described together with description of an apparatus for manufacturing a product filled with hydrogen water. Here, in the specification, while hydrogen water with which a container (in the present invention, a can container) in a sealed state is filled and packed is referred to as “the product 10 filled with hydrogen water,” it may be simply referred to as “the filled product 10.”

### [Reviews and Considerations on Preservation Properties of Hydrogen Water]

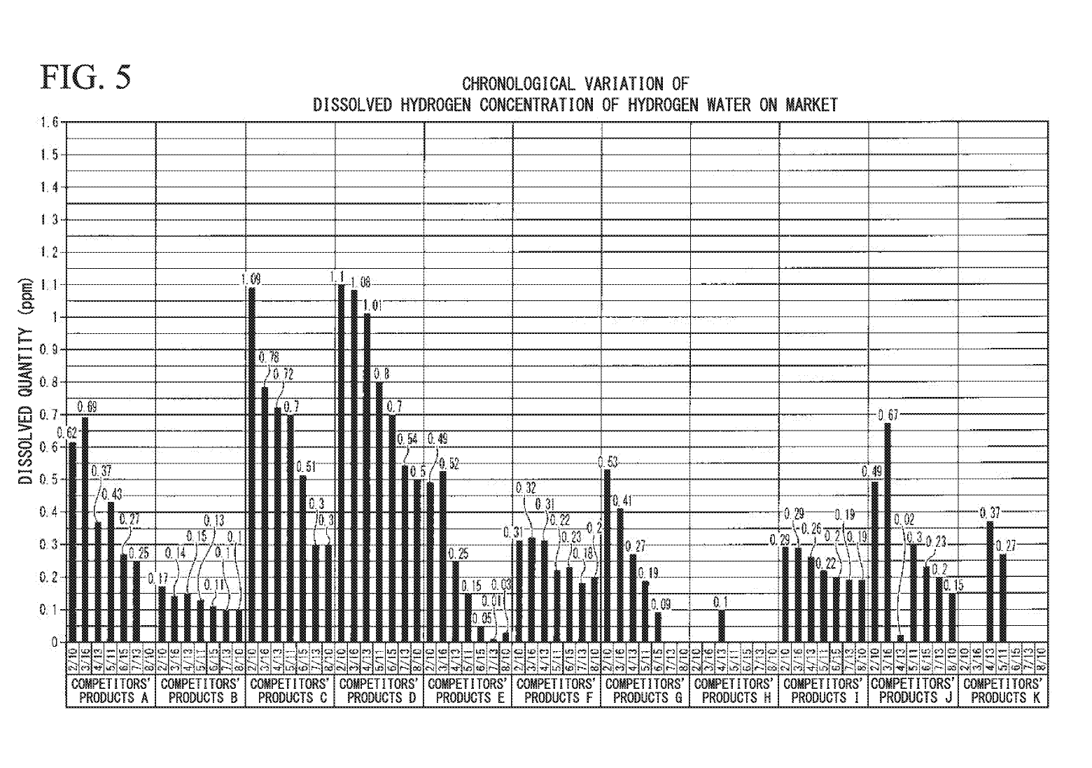

The inventor(s) first chronologically (here, about every month over six months) measured concentrations of “packaged hydrogen water” that is on the market, as a first step of recognizing problems of preservation properties of hydrogen water in the current situation. The obtained results are shown in FIG. 5. Here, products A to K of respective companies were used as goods of the same lot (goods manufactured under the same conditions). In addition, while “packaged hydrogen water” purchased as samples was three types of

(1) PET bottle packaging

(2) Aluminum pouch packaging and

(3) Aluminum bottle packaging,

products of a PET bottle type (1) had a dissolved hydrogen concentration of “0 (zero)” upon measurement (for example, competitor's products H, K, and so on), which could not be measured chronologically.

In addition, it was apparent that, while there were filled products having remarkably low dissolved hydrogen concentrations among the competitors' products A to K that are on the market even immediately after the filled products were purchased, cases in which the dissolved hydrogen concentration chronologically decreased with (2) aluminum pouch packaging and (3) aluminum bottle packaging to about a half of an initial concentration after three months were recognized, and in the types of (2) aluminum pouches and (3) aluminum bottles, “the hydrogen water” could not be preserved for a long time. Further, measurement of the dissolved hydrogen concentration was performed using a dissolved hydrogen meter “DH-35A” manufactured by Toa DKK Corporation.

In addition, in the results of FIG. 5, while there were filled products that showed values exceeding the initially measured concentration after one month had elapsed and filled products that showed values exceeding the one-month numerical value (the dissolved hydrogen concentration) when two months had elapsed, this was due to the fact that, since the sealed products had to be uncapped whenever the measurements were performed, in the actual experiment, different (individual) samples of the same products manufactured by the same manufacturer were measured at the time of the lapse of one month and the time of initial measurement (once uncapping is performed, since hydrogen is likely to escape due to contact with air even if recapping is performed, measurements cannot be performed on completely the same sample). That is, even when the dissolved hydrogen concentration is shown to have increased in the data, the concentration did not increase in actuality but rather a sample error (an individual difference) occurred in the same product, and thus, as shown in FIG. 5, the overall trend should be obtained by surveying the entire data measured over a long time, for example, about six months.

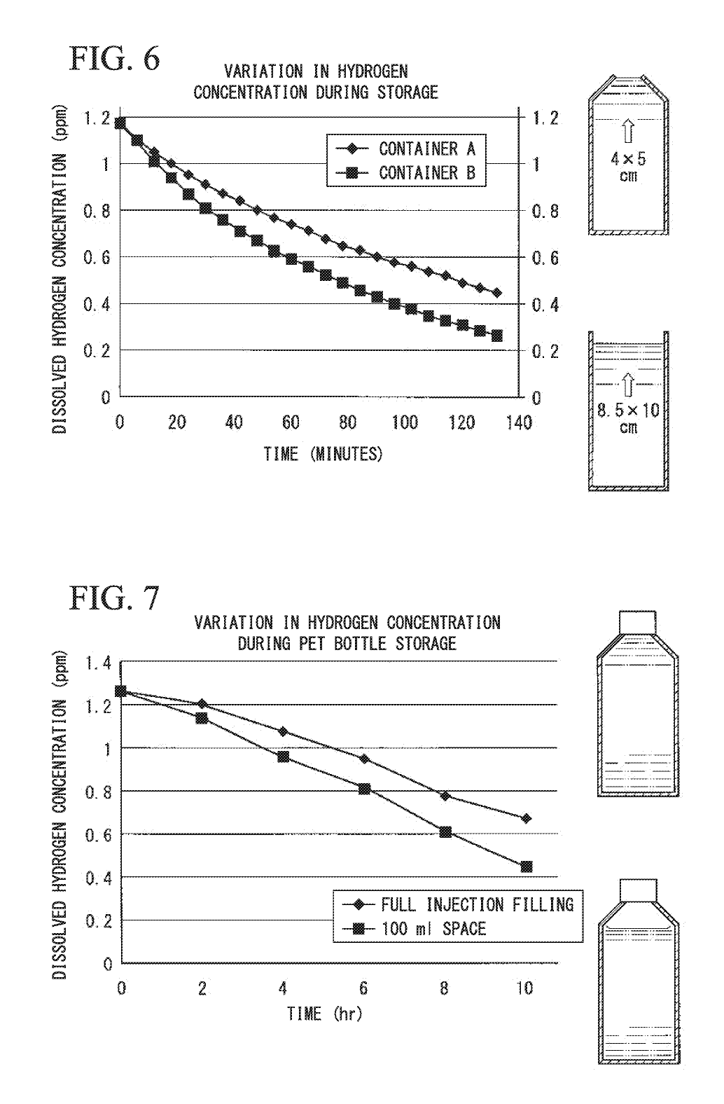

Next, in order to clarify factors exerting an influence on the preservation properties of hydrogen water, two containers in which an air contact area was varied were filled with hydrogen water, and how the dissolved hydrogen concentration varied with the passage of time was measured. The obtained results are shown in FIG. 6. As will be apparent from the graph of FIG. 6, a container having a larger air contact area has a larger decrease in the dissolved hydrogen concentration, and after two hours (120 minutes) had elapsed in the experiment, the dissolved hydrogen concentration had decreased to ¼ or less of the initial concentration. From the result, it was understood that, when “the hydrogen water” comes in contact with air, hydrogen escapes from “the hydrogen water,” and for this reason, it was concluded that blocking contact with air is extremely effective in preservation of packaged “hydrogen water.”

Next, verification of whether preservation of “the hydrogen water” is possible when the hydrogen water packaged in the PET bottle was not in contact with air, specifically, when the bottle was filled with “the hydrogen water” to a full injection state such that air did not enter the PET bottle (no head space occurred) was performed. The obtained result is shown in FIG. 7. It was understood from the drawings that, even when the PET bottle was filled with the hydrogen water to the full injection state, when 10 hours had elapsed, the concentration had decreased to half of the initial dissolved hydrogen concentration. Of course, it was understood that the dissolved hydrogen concentration in the case in which the head space was provided further decreased to be lower than that in the case of the full injection filling.

Considering the fact that the dissolved hydrogen concentration of the hydrogen water in the PET bottle decreased, the “gas permeability” of synthetic resins was considered to be involved. For example, according to a literature comparing gas permeability with respect to a rubber, it was understood that hydrogen shows gas permeability with respect to the rubber about five times that of nitrogen, and about two times that of oxygen.

hydrogen (MW=2) 1.4

helium (MW=4) 1.0

oxygen (MW=32) 0.8

nitrogen (MW=28) 0.3

While accurate comparison data could not be obtained, like the rubber, it is obvious from various literatures that PET bottles also have gas permeability, and in particular, it is obvious that the gas permeability of hydrogen having the smallest molecular size is stronger than those of other gas species. It was assumed to be for this reason that the dissolved hydrogen concentration reduced within several hours even when the PET bottle was filled with the hydrogen water to the full injection state.

In addition, the dissolved hydrogen concentration was reduced even in the aluminum cap bottle formed of a metal, through which hydrogen cannot easily pass, that appeared to be completely sealed, and considering this point, in the case of the aluminum cap bottle, since the bottle was sealed with a synthetic resin or silicon packing adhered to the inside of the cap (sealed such that the hydrogen water did not leak), a minute amount of the hydrogen contained in the hydrogen water was assumed to have passed through the packing to escape to the outside of the bottle.

As described above, in consideration of the factors that exert an influence on preservation properties of hydrogen water, in preservation of the hydrogen water, the present invention is the result of the conclusion that the method of adopting the following three items is effective.

(A) A metal can formed of a material through which hydrogen cannot easily pass (both steel and aluminum are acceptable) is used.

(B) In particular, in a sealing-filled state, hydrogen water should not come in contact with any gas other than hydrogen, for example, air or the like.

(C) When a can is sealed through packing, a used amount of synthetic resins having gas permeability is reduced as much as possible.

As a result, in the present invention, the hydrogen water is filled in the metal can in the full injection state such that no head space is generated, and the hydrogen water after filling and sealing does not come in contact with any gas other than hydrogen.

That is, the present invention is provided to manufacture of a filled product 10 using a method that satisfies the above-mentioned conditions (A) to (C) and suppresses a decrease in the dissolved hydrogen concentration of the hydrogen water.

Next, a name of the filled product 10 or a can body when the filled product 10 is manufactured will be described.

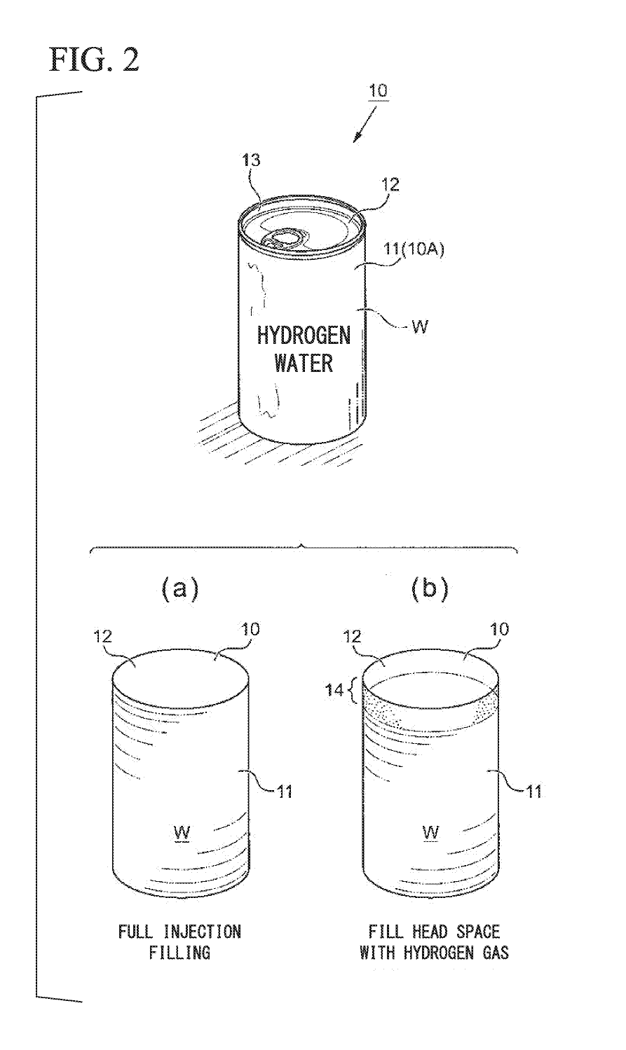

Further, in the following description, as shown in FIG. 2(a), the filled product 10 in which the can container is filled with hydrogen water W after generation to a full injection state such that a head space 14 does not occur in the can (at an upper section) will be exemplarily described.

In addition, here, as an example, as shown in FIG. 2, while a full-opening end can (a full-opening lid) in which a pull tab does not enter the contents (the hydrogen water W) when a can lid is opened is supposed, a stay-on tab can (SOT can) in which a pull tab enters the contents upon uncapping is also acceptable.

The filled product 10 is a can body in which a can container 10A is filled with hydrogen water and then a lid is capped to seal and isolate the hydrogen water from the outside. Here, reference numerals “11” and “12” designate a can trunk section and a can lid section, and a rising section from an opening surface of the can lid section 12 to an upper end portion of the can trunk section 11 is referred to as “a rising section 13.”

Incidentally, the can container 10A has a bottomed cylinder shape having a can bottom (a bottom lid) formed at the can trunk section 11 (i.e., in a state in which the can lid section 12 is not attached), and to obtain the can container 10A, the can trunk section 11 and can bottom section may be integrally formed through drawing (as a so-called 2-piece can) or the can trunk section 11 and the can bottom section may be separately formed and then bonded to each other (as a so-called 3-piece can).

In addition, a use of the hydrogen water W is mainly supposed to be as a beverage, and in the case of a beverage, once uncapped, the hydrogen will escape from the hydrogen water W over time, and thus it is assumed that a consumer will drink it immediately after uncapping it. In addition, for this reason, a volume of the can filled with the hydrogen water W is mainly supposed to be a relatively small volume (a so-called “one-shot drinking size”) of about 100 to 350 milliliters. However, an application of the hydrogen water is not limited to drinking but of course it is also supposed to be used for cosmetics, skin lotion, or the like. In addition, in the future, industrial application is also conceivable. For this reason, the volume is not limited to the “drink size,” but a large volume, a so-called pail can or drum can, is also be supposed as a can body, and in this case, in sealing the can lid section 12 to the can trunk section 11, not only seaming but also using a separate clamp or welding is also considered.

In addition, for this reason, as long as the filled product 10 (the can body) is for drinking, it is generally a cylindrical shape, but it is not necessarily limited to this.

Further, the hydrogen water W is adjusted by dissolving hydrogen gas in raw water such as distilled water or the like, and hydrogen is preferably dissolved to as high a concentration as possible, i.e., a saturated concentration or a state close to the saturated concentration. In addition to the above-mentioned distilled water, tap water or the like is also considered as the raw water.

Further, the various methods mentioned above are used as the method of generating the hydrogen water W, and either of these can generate the hydrogen water W having a high concentration close to the saturated concentration. However, even in the hydrogen water W generated at a high concentration, since the dissolved hydrogen concentration of the hydrogen water W is varied according to the filling method itself, i.e., how the hydrogen water W is packed in the can container 10A, hereinafter, a preferable method during filling (cautionary notes) will be described.

The dissolved hydrogen concentration of the hydrogen water that is on the market as described above is about 0.1 to 1.0 ppm in many products. However, when a container having low preservation properties of hydrogen is filled with the hydrogen water, the dissolved hydrogen concentration is chronologically decreased even in a state in which the lid is sealed, and a function as the hydrogen water is remarkably decreased. Moreover, since hydrogen has a property of easily escaping from water, manufacturing hydrogen water having a high concentration is useless if the hydrogen escapes during filling.

Here, in the embodiment, when the can container 10A is filled with the hydrogen water W, a contact time or a contact area with other gases is reduced, and a filling speed or a positional relation between the can container 10A during filling and a water injecting nozzle 31n for the hydrogen water W is considered. Further, during filling, although not a little hydrogen water W may come in contact with another gas, the container can be filled with the hydrogen water W at a higher concentration and sealed by overflowing the contacted hydrogen water W from the can container 10A (full injection filling).

Hereinafter, a manufacturing method will be described while describing an apparatus for manufacturing such a filled product 10 (hereinafter referred to as “a filled product manufacturing apparatus 1”).

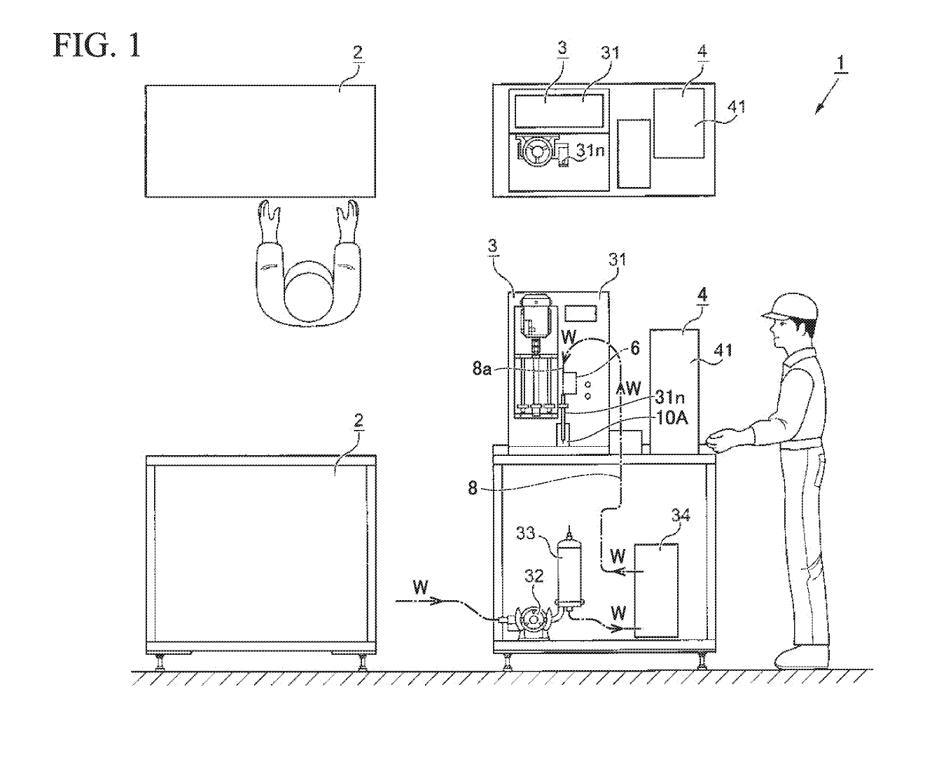

As an example, as shown in FIG. 1, the filled product manufacturing apparatus 1 includes a hydrogen water generating apparatus 2 configured to dissolve and contain hydrogen in raw water to a desired concentration, a hydrogen water filling apparatus 3 configured to fill the can container 10A with the generated the hydrogen water W (through injection), and a can lid sealing apparatus 4 configured to seal (attach) the can lid section 12 onto the can container 10A (the can trunk section 11).

Here, since any of the above-mentioned methods can be employed to obtain the hydrogen water W, in the following description, the hydrogen water generating apparatus 2 will be omitted, and the hydrogen water filling apparatus 3 and the can lid sealing apparatus 4 will be described.

As an example, as shown in FIG. 1, the hydrogen water filling apparatus 3 includes a filling machine main body 31 configured to inject the hydrogen water W generated by the hydrogen water generating apparatus 2 in the previous step into the can container 10A, a pump 32 configured to transport the hydrogen water W toward the filling machine main body 31, a purifying apparatus 33 such as a filtration filter or the like configured to purify the hydrogen water W, a sterilization apparatus 34 (for example, a UV sterilization apparatus) configured to sterilize the hydrogen water W, and a pressure adjustment mechanism 6 installed in a filling pipeline 8 of the hydrogen water W. The can container 10A used in the filling process is formed in a bottomed cylindrical shape, in which the can lid section 12 is not sealed, such that injection of the hydrogen water W serving as contents can be performed.

The filling machine main body 31 includes the water injecting nozzle 31n configured to pour the hydrogen water W into the can container 10A.

In the embodiment, the water injecting nozzle 31n is configured to be movable up and down. In addition, the hydrogen water W with which the can container 10A is filled overflows both when the can container 10A is filled with the hydrogen water W and when the can container 10A (the can trunk section 11) is covered with the can lid section 12 after filling. Drainage equipment such as a drain pipe or the like is preferably installed at a portion of a placing table on which the can container 10A is set to the filling machine main body 31 to fill the container with the hydrogen water W to a full injection state. Further, when these overflows are distinguished from each other, the overflow of the hydrogen water W from the can container 10A during filling is referred to as primary overflow, and the overflow of the hydrogen water W from the can container 10A when the can lid section 12 is attached is referred to as secondary overflow.

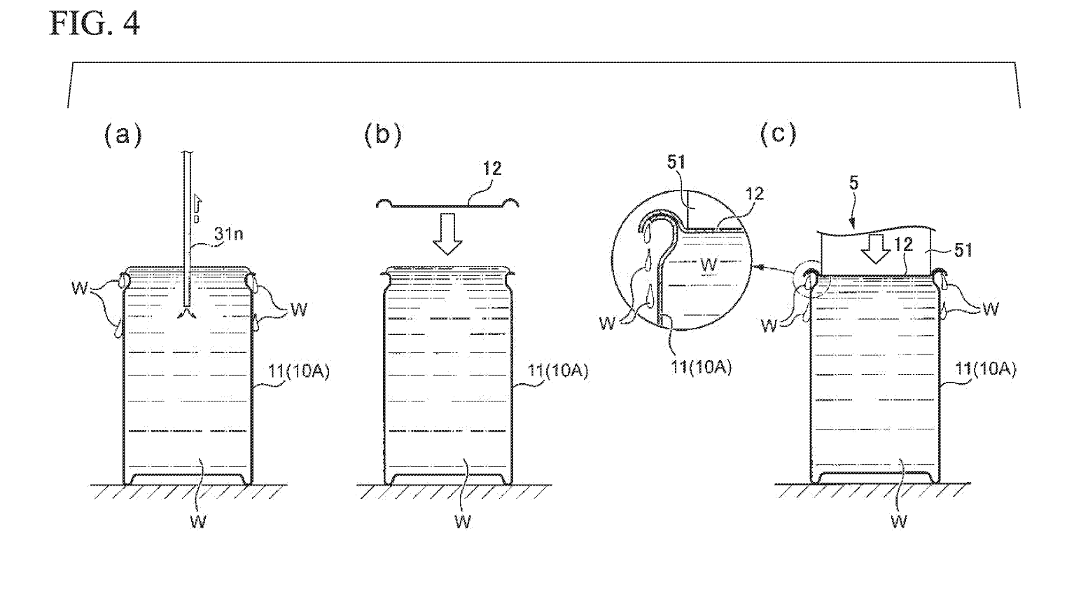

In addition, as shown in FIG. 4, the filling machine main body 31 includes a pressurization mechanism 5 configured to push the hydrogen water into the can container 10A while applying a predetermined pressure to the can lid section 12 in a process of attaching the can lid section 12 to the can container 10A.

The pressurization mechanism 5 is constituted by an actuator (not shown) such as a hydraulic piston or the like, and a pressurizing section 51 configured to press the can lid section 12.

The pressurizing section 51 is formed in a columnar shape as a whole. The pressurizing section 51 is movable in a direction approaching or moving away from the can container 10A set on the portion of the placing table by the hydraulic piston. A diameter of the pressurizing section 51 is substantially the same as that of an inner shape of an opening section of the can container 10A. One end surface of the pressurizing section 51 in the axial direction can abut a surface of the can lid section 12. Accordingly, the pressurizing section 51 of the pressurization mechanism 5 can attach the can lid section 12 to the can container 10A while pressing the hydrogen water in a supersaturated state on substantially the entire surface of the can lid section 12.

The pressurization mechanism 5 push the hydrogen water into the can container 10A while applying a predetermined pressure to the can lid section 12 in a process of attaching the can lid section 12 to the can container 10A when the can lid section 12 is sealed onto the can container 10A. Further, a magnitude of the pressure from the pressurization mechanism 5 is not particularly limited but is set to, for example, about 300 kg/cm² in the embodiment.

As shown in FIG. 1, the filled product manufacturing apparatus 1 includes the pressure adjustment mechanism 6. The pressure adjustment mechanism 6 connects the hydrogen water generating apparatus 2 and the water injecting nozzle 31n, and is installed upstream from the water injecting nozzle 31n in a transferred direction of the hydrogen water W in the filling pipeline 8 through which the hydrogen water W with which the container is filled flows. In the embodiment, the pressure adjustment mechanism 6 is installed above the water injecting nozzle 31n in the filling pipeline 8a between the water injecting nozzle 31n and the sterilization apparatus 34.

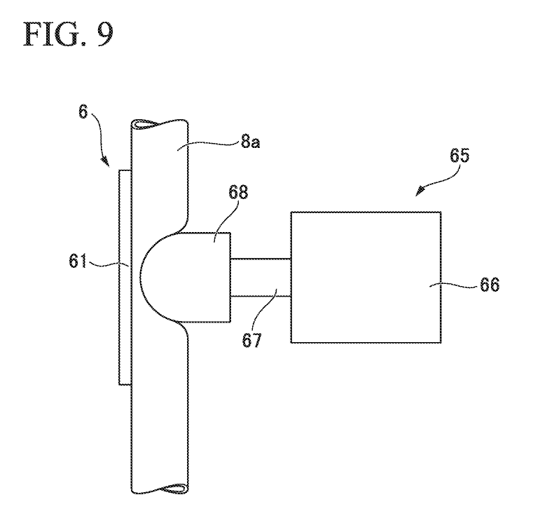

FIG. 9 is a view for describing the pressure adjustment mechanism 6.

As shown in FIG. 9, the pressure adjustment mechanism 6 of the embodiment includes a keep plate 61 and a pinch valve 65.

The keep plate 61 is a member having an elongated plate shape. The keep plate 61 is disposed in a state in which a longitudinal direction thereof coincides with an extension direction of the filling pipeline 8a. One main surface of the keep plate 61 is disposed in contact with an outer circumferential surface of the filling pipeline 8a.

The pinch valve 65 changes a flow path area of the hydrogen water W by compressing the filling pipeline 8a. The pinch valve 65 includes a main body section 66, a shaft 67 having one end disposed in the main body section 66, and a biasing section 68 attached to the other end of the shaft 67.

The pinch valve 65 is installed at an opposite side of the keep plate 61 with the filling pipeline 8a disposed therebetween.

While various types are considered as the pinch valve 65, in the embodiment, for example, an air cylinder type that is movable by injection and suction of air is employed. The air cylinder is installed in the main body section 66. Further, the pinch valve 65 is not limited to the air cylinder type but may be a hydraulic cylinder type. In addition, the pinch valve 65 may be an electromagnetic (plunger type) valve. When the pinch valve 65 is the electromagnetic valve, a coil is installed in the main body section 66.

The biasing section 68 attached to the other end of the shaft 67 compresses the filling pipeline 8a at a predetermined pressure. When the hydrogen water W flows through the filling pipeline 8a, the biasing section 68 is pushed back toward the main body section 66 to resist the biasing force of the biasing section 68. Accordingly, a pressure of the hydrogen water W in the filling pipeline 8a is held to be substantially constant within a predetermined range. That is, the pressure adjustment mechanism 6 functions as a pressure regulator. According to the configuration, in the process of filling the can container 10A with the hydrogen water W, since the filling is performed in a state in which the pressure in the filling pipeline 8a is maintained within the predetermined range by the pressure adjustment mechanism 6, the hydrogen water W is filled with hydrogen during transport until the pressure in the filling pipeline 8a is increased to the predetermined range by the pressure adjustment mechanism 6. Accordingly, in comparison with the related art, the hydrogen water W can be filled with a larger amount of hydrogen to suppress discharge of the hydrogen.

Next, an example of an injection state when the can container 10A is filled with the hydrogen water W and effects thereof will be described.

In filling the can container 10A with the hydrogen water W, except at the beginning of the filling with the hydrogen water W, the filling is performed in a submerged state in which an ejection port of the water injecting nozzle 31n is disposed under a water surface of the hydrogen water W already injected into the can container 10A (a state in which the ejection port is immersed in the injected hydrogen water W) (submersion filling), and for this reason, the water injecting nozzle 31n is formed to be movable up and down.

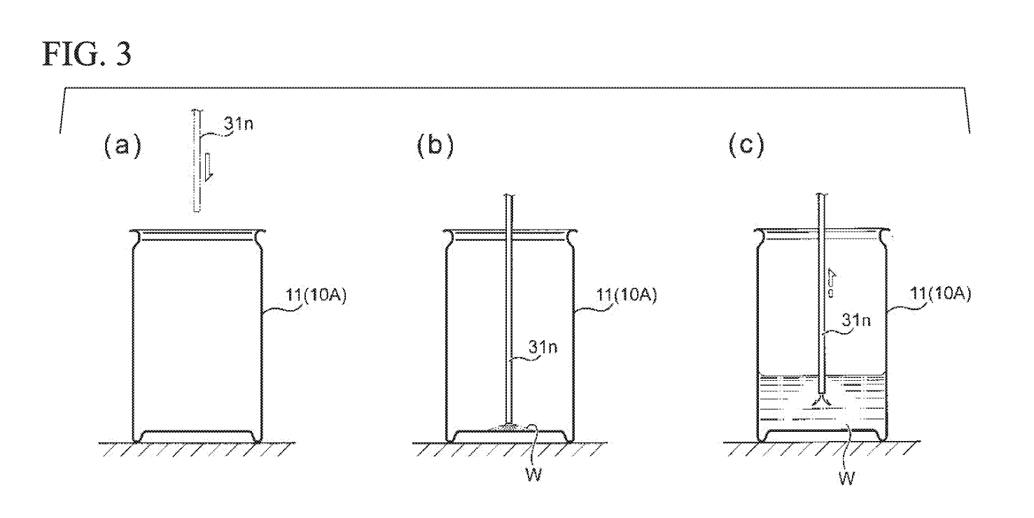

That is, as an actual operation of the water injecting nozzle 31n, for example, as shown in part (a) of FIG. 3 and part (b) of FIG. 3, the water injecting nozzle 31n is first lowered to the vicinity of the bottom section of the can container 10A (a separation distance between the nozzle ejection port and the can bottom section at this time is different according to a filling speed or the like, and is determined in consideration of rebounding from the can bottom section), and in this state, the filling with the hydrogen water W starts. After that, as sequentially shown by part (c) of FIG. 3 and part (a) of FIG. 4, the ejection port of the water injecting nozzle 31n is preferably immersed in the hydrogen water W injected into the can container 10A.

Further, here, according to advance of the filling, an embodiment in which the filling is performed while gradually raising the water injecting nozzle 31n (the ejection port) is shown in the drawings, and here, for example, the water injecting nozzle 31n can be gradually raised such that a distance between the liquid surface of the hydrogen water W injected into the can container 10A and the nozzle ejection port is constantly maintained. That is, according to advance of the filling, the water injecting nozzle 31n can be gradually raised such that the nozzle ejection port follows the liquid surface of the hydrogen water W injected into the can container 10A.

In addition, the same operation as above can be performed by raising and lowering the placing table as long as the placing table on which the can container 10A is set during filling is movable up and down. In this case, it is not necessary to configure the water injecting nozzle 31n to be movable up and down. That is, an elevation operation of the water injecting nozzle 31n may be relatively performed with respect to the placing table on which the can container 10A is set during filling.

Then, when such an injection state (submerging filling) is employed, an impact of the hydrogen water W injected into the can container 10A during filling or contact with air or another gas is suppressed, and escape of hydrogen from the hydrogen water W can be prevented as much as possible.

Further, in the embodiment, the pressurization mechanism 5 is provided, and in a process of attaching the can lid section 12 to the can container 10A in filling the hydrogen water W in the can container 10A, the hydrogen water is pushed into the can container 10A while a predetermined pressure is applied to the can lid section 12.

According to the configuration, since both of the primary overflow when the container is filled with the hydrogen water W and the secondary overflow when the can lid section 12 is attached are performed, metal can body can be reliably filled with the hydrogen water W at the full injection state.

In addition, in the process of attaching the can lid section 12 to the can container 10A, since the hydrogen water is pushed into the can container 10A while a predetermined pressure is applied to the can lid section 12 in the secondary overflow state and sealing of the can lid section 12 onto the can container 10A is performed, the can container 10A is filled with the hydrogen water W at the full injection state while a pressure is applied to the hydrogen water W after generation, and thus, it is possible to prevent the head space 14 in the can. Accordingly, discharge of the hydrogen from the hydrogen water W can be suppressed while the container is filled at the full injection state with the hydrogen water W in a supersaturated state.

Further, the inventor(s) performed an experiment of comparing the above-mentioned submersion filling with the case in which the water injecting nozzle 31n (the ejection port) is installed at a position higher than the upper end of the can container 10A (the can trunk section 11) (i.e., the non-submersion filling in which the nozzle ejection port is not submerged in the hydrogen water W during filling). Accordingly, the inventor(s) recognized that emission of the hydrogen was lower in the submersion filling than in the non-submersion filling. This is because, in the non-submersion filling, the nozzle ejection port is always set to a position higher than the upper end of the can container 10A. Because the non-submersion filling is performed while the hydrogen water is hitting the water surface from the high position, hydrogen is considered to escape from the hydrogen water W while the hydrogen water W entrains air during filling. Accordingly, in the embodiment, the submersion filling is employed.

In addition, the inventor(s) also performed an experiment of investigating an influence of a difference in the filling speed on the change of the dissolved hydrogen concentration. The experiment is an example in which the dissolved hydrogen concentrations were compared at filling speeds of 2 liter/1 minute and 1 liter/1 minute. As a result, although no remarkable difference due to the difference in filling speed appeared, it turned out that the lower speed of 1 liter/1 minute tended to hold a somewhat higher concentration.

Next, the can lid sealing apparatus 4 will be described. The can lid sealing apparatus 4 is an apparatus for sealing (encapsulating) the can lid section 12 onto the can container 10A (the can trunk section 11) after filling while pressing the can lid section 12 with a predetermined pressure. In other words, the can lid sealing apparatus is an apparatus for sealing the can body and blocking the hydrogen water W with which the can body is filled (here, full injection filling) from an external space, and here, employs a double seaming technique used when a lid is attached to a can. For this reason, as an actual example of the can lid sealing apparatus 4 in the embodiment, a seamer 41 is provided. Here, the double seaming is a method of wrapping the can lid section 12 (a circumferential edge curl portion) in a flange portion of the can trunk section 11 (an upper edge) and bonding them through pressure joining.

During sealing of the can lid section 12, as an example, first, as shown in a part (b) of FIG. 4, the hydrogen water W is made to overflow from the can container 10A (the above-mentioned secondary overflow) when the can lid section 12 is placed on (covers) the upper edge of the can container 10A (the can trunk section 11) filled with the hydrogen water W. Next, as shown in a part (c) of FIG. 4, the hydrogen water is pushed into the can container 10A while a predetermined pressure (for example, 300 kg/cm²) is applied to a surface of the can lid section 12, and sealing of the can lid section 12 with respect to the can container 10A is performed. Accordingly, sealing of the can lid section 12 can be performed in a state in which there is no head space 14 at an upper portion of the can body.

In this way, in the process of attaching the can lid section 12 to the can container 10A, since the secondary overflow is generated because the hydrogen water is pushed into the can container 10A while a predetermined pressure is applied to the can lid section 12, discharge of the hydrogen from the hydrogen water W can be suppressed while the container is filled to the full injection state with the hydrogen water W in the supersaturated state. Further, in the process of attaching the can lid section 12 to the can container 10A, since the hydrogen water is pushed into the can container 10A while a predetermined pressure is applied to the can lid section 12 in the secondary overflow state and sealing of the can lid section 12 onto the can container 10A is performed, the can container 10A can be filled with the hydrogen water W to the full injection state while a pressure is applied to the hydrogen water W after generation such that the head space 14 does not occur in the can. Accordingly, discharge of the hydrogen from the hydrogen water W can be suppressed while the container is filled at the full injection state with the hydrogen water W in the supersaturated state.

Further, even in a base portion of the seamer 41 configured to directly or indirectly support the can container 10A (the can body), like the hydrogen water filling apparatus 3, drainage equipment such as a drain pipe or the like through which secondary overflow is possible may be installed.

The filled product manufacturing apparatus 1 according to the present invention is configured as described above. Hereinafter, a preferable embodiment or the like of the can body in actual use of the filled product 10 (the can body) (for example, a full-opening end (a full-opening lid) shown in FIG. 2 for full injection filling is preferable) will be described.

When the container is filled to the full injection state with contents having low viscosity such as mineral water or the like, during uncapping, some of the contents may be scattered. For example, in a stay-on tab (SOT) can, because a pull tab enters the contents during uncapping, the contents are eventually pushed out, and scattered and sprayed to surroundings in a splash pattern. In particular, in the case of the SOT can, users (drinkers) are considered to frequently hold the can with one hand and uncap the pull tab with the other hand, and thus the contents are likely to be scattered unnecessarily because the can body is held in an unstable state.

Such scattering of contents during uncapping can be assumed to cause complaints from consumers. As a means for solving the problems, as shown in FIG. 2, a full-opening end having a pull tab that does not enter contents is considered to be preferable. According to the full-opening end type, since uncapping is often performed in a state in which a can is stably placed on a desk, a table, or the like, during uncapping, scattering of contents to surroundings can be considered to be further prevented.

Further, when the head space 14 is formed in the filled product 10 shown in FIG. 2(b), i.e., in the can body (an upper portion), and hydrogen gas is filled therein, in the SOT can as well as the full-opening end, it is possible to more reliably prevent scattering of contents (spill prevention) during uncapping.

In addition, in the full-injection-filled product 10, when a height of “the rising section 13” shown in FIG. 2 is low, a liquid surface of the hydrogen water W during uncapping becomes substantially equal to a height of the upper end of the can trunk section 11 (an edge of the can). For this reason, in order for the hydrogen water W not to spill when the first sip is taken, the uncapped filled product 10 should be carried to the mouth in a horizontal state, and problems such as difficulty in drinking occur.

As a means for solving the problems, a dimension of the rising section 13 may be secured at about 5 to 10 mm. Accordingly, the rising section 13 functions as a weir, and can eliminate the drinking difficulty when the first sip is taken. Further, it is possible to prevent scattering of contents to the surroundings during uncapping.

Next, effectiveness of preservation properties of the filled product 10 manufactured by the manufacturing method of the present invention will be described. First, immediately after 200-milliliter SOT cans formed of steel were filled with distilled water having a dissolved hydrogen concentration that was increased to 1.4 ppm (the hydrogen water W) to a full injection state by a micro baffle method, double seaming was performed using a seamer manufactured by Toyo Seikan Co., Ltd.

The packaged hydrogen water W was stored in a thermostatic tank at 37° C. (assuming summer), two cans among these were extracted every week, and dissolved hydrogen concentrations were measured. Further, measurement of the dissolved hydrogen concentrations was performed using a dissolved hydrogen meter “DH-35A” manufactured by Toa DKK Corporation.

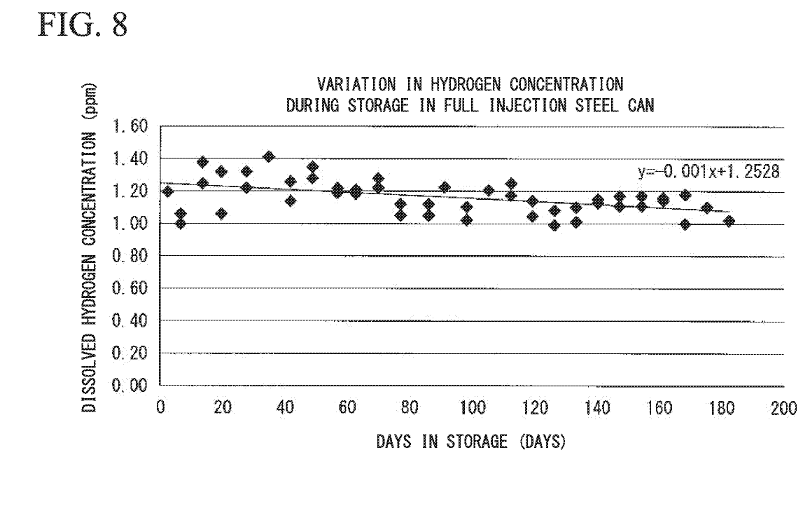

The obtained results are shown in FIG. 8, which shows almost no reduction in dissolved hydrogen concentration, and the dissolved hydrogen concentration was 1.0 ppm or more even after 6 months (180 days) had elapsed.

In addition, the following linear regression equation was obtained from this measurement result and the fluctuation of the hydrogen concentration over 6 months was calculated statistically.

y=−0.001x+1.2528

(y: hydrogen concentration, x: days in storage)

According to this regression equation, it was found that, when the initial value is 1.25 ppm, the estimated value of the hydrogen concentration after 6 months is 1.07 ppm and the decreasing rate of the hydrogen concentration in 6 months of storage is about 14%. This indicates that the hydrogen water W can be preserved while maintaining the hydrogen at the high concentration of 1 ppm or more even in the middle of summer when the dissolved hydrogen concentration during filling is 1.25 ppm or more, and it was confirmed that the present invention is superior as a preservation method of hydrogen water W.

Meanwhile, FIG. 5 shows results obtained by measuring dissolved hydrogen concentrations of competitors' products stored at a normal temperature as described above approximately every month for six months. Products that had a dissolved hydrogen concentration of 1 ppm or more upon start of measurement were only 2 articles among the 11 articles, which objectively shows the difficulty of filling the container while maintaining the dissolved hydrogen concentration in the container at a high concentration. Simultaneously, even in products showing high concentrations of 1 ppm or more, the dissolved hydrogen concentration decreased to 0.7 to 0.8 ppm after 3 months of storage (far below 1 ppm). Like the filled product 10 according to the present invention, linear regression equations were obtained from the measurement results of the 2 products (the 2 articles), hydrogen concentration decreasing rates of the two products after 3 months of storage were statistically calculated as 29 to 37%, and in the case of 6 months of storage, hydrogen concentration decreasing rates were calculated as 59 to 75%. In this regard, as described above, a decreasing rate of the hydrogen concentration in the 6 months of storage of the filled product 10 according to the present invention is about 14%, and thus it is apparent that the filled product 10 according to the present invention suppresses the decrease of the hydrogen concentration to ¼ to ⅕ that of the competitors' products, which is an excellent effect of the filled product 10 according to the present invention.

Further, it was also found that, when the initial hydrogen concentration of the hydrogen water is a low concentration of 0.4 ppm or less, a decreasing rate of the hydrogen concentration in a preservation period tends to be reduced, and when the decreasing rate of the hydrogen concentration in the preservation period is compared, comparison with the high concentration of the hydrogen water of 1 ppm or more is important.

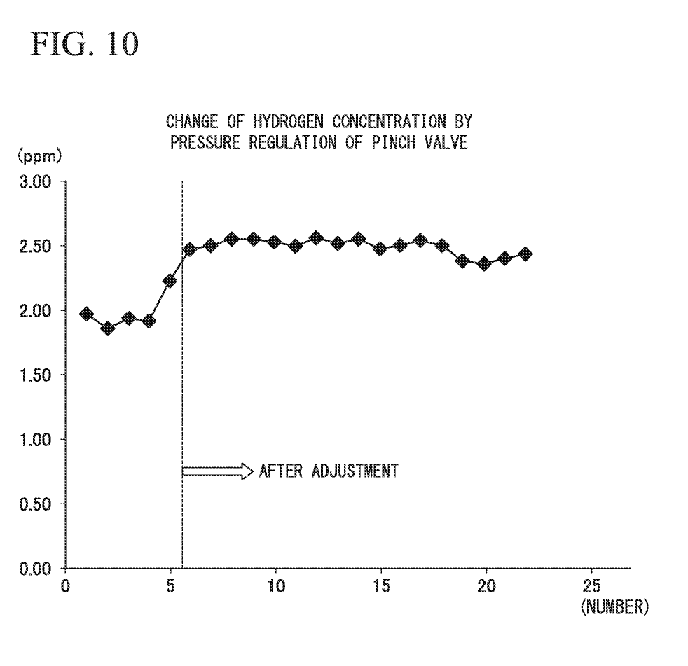

FIG. 10 is a graph showing a change of a hydrogen concentration due to application of the pressure adjustment mechanism.

In the graph shown in FIG. 10, a lateral axis represents a number of products filled with the hydrogen water W manufactured, and a vertical axis represents a dissolved hydrogen concentration. In addition, for the sixth and later products filled with the hydrogen water W that were manufactured, the pressure in the filling pipeline 8a was held in the predetermined range by applying the pressure adjustment by the pressure adjustment mechanism 6.

As shown in FIG. 10, it was found that, in the process of filling the can container 10A with the hydrogen water W, when pressure regulation by the pressure adjustment mechanism 6 was applied, a hydrogen concentration of about 1.25 times was obtained in comparison with the case in which pressure regulation by the pressure adjustment mechanism 6 was not applied. Thus, in the embodiment, the pressure adjustment mechanism 6 is provided, and in the process of filling the can container 10A with the hydrogen water W, the pressure of the hydrogen water W in the filling pipeline 8a is held to be substantially constant within a predetermined range.

According to the above-mentioned configuration, because the process of filling the can container 10A with the hydrogen water W is performed in a state in which the pressure in the filling pipeline 8a is held within a predetermined range by the pressure adjustment mechanism 6, the hydrogen water W is filled with hydrogen during transport until the pressure in the filling pipeline 8a is increased to the predetermined range by the pressure adjustment mechanism 6. Accordingly, in comparison with the related art, the hydrogen water W can be filled with a larger amount of hydrogen to suppress discharge of the hydrogen.

Further, the present invention is not limited to the above-mentioned embodiment but various modifications may be added to the above-mentioned embodiment without departing from the scope of the present invention.

While the pressurization mechanism 5 is constituted by the actuator (not shown) such as a hydraulic piston or the like and the pressurizing section 51 configured to press the can lid section 12 in the above-mentioned embodiment, it is not limited thereto. Accordingly, as the pressurization mechanism 5 for example, an electromagnetic actuator or the like may be employed instead of the hydraulic piston.

In addition, in the above-mentioned embodiment, a magnitude of the pressure by the pressurization mechanism 5 is set to, for example, about 300 kg/cm². However, the magnitude of the pressure by the pressurization mechanism 5 is not particularly limited, and various settings corresponding to a quantity of hydrogen contained in the hydrogen water W, a shape and a size of the can container 10A, or the like, are possible.

While the pressure adjustment mechanism 6 is constituted by the keep plate 61 and the pinch valve 65 in the above-mentioned embodiment, it is not limited thereto. Accordingly, for example, a variable valve may be employed in place of the pinch valve 65 and feedback control may be performed by installing, for example, a pressure sensor, and the pressure of the hydrogen water W in the filling pipeline 8a may be controlled substantially constant.

In addition, it is possible to appropriately replace the components in the embodiment with well-known components without departing from the scope of the present invention.

The present invention can be applied not only as a preservation technique for hydrogen water for drinking (a beverage) but also as a preservation technique of hydrogen water for cosmetics (skin lotion) rather than drinking, and may also be applied in industrial fields.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A method of manufacturing a product filled with hydrogen water, the method comprising:
generating hydrogen water in which hydrogen is dissolved by mixing raw water and hydrogen gas, filling a metal can container with the hydrogen water, and then covering a can trunk section of the can container with a can lid section and sealing the can lid section onto the can trunk section,
wherein, in a sealed state in which the can lid section is sealed onto the can trunk section, the hydrogen water that is filled in a can body is filled and sealed in a state in which the hydrogen water is not in contact with any gas other than hydrogen and the hydrogen water is in a direct contact with an inner surface of the can body,
when the filling and sealing is performed,
the can body is filled with the hydrogen water to a full injection state by performing at least both of:
a primary overflow that overflows the hydrogen water from the can container in a process of filling the can container with the hydrogen water, and
a secondary overflow that overflows the hydrogen water from the can body in a process of attaching the can lid section to the can container filled with the hydrogen water, and
in the process of attaching the can lid section to the can container, the hydrogen water is pushed into the can container while a predetermined pressure is applied to the can lid section while the secondary overflow state is maintained and sealing of the can lid section with respect to the can container is performed.

2. The method of manufacturing the product filled with hydrogen water according to claim 1,
wherein, in the process of attaching the can lid section to the can container, sealing of the can lid section with respect to the can container is performed by pushing the hydrogen water into the can container while a predetermined pressure is applied to a surface of the can lid section.

3. The method of manufacturing the product filled with hydrogen water according to claim 1,
wherein, in the process of attaching the can lid section to the can container, sealing of the can lid section with respect to the can container is performed by a double seaming technique of wrapping and pressure bonding a circumferential edge of the can lid section to a flange portion of an upper edge of the can trunk section.

4. The method of manufacturing the product filled with hydrogen water according to claim 2,
wherein, in the process of attaching the can lid section to the can container, sealing of the can lid section with respect to the can container is performed by a double seaming technique of wrapping and pressure bonding a circumferential edge of the can lid section to a flange portion of an upper edge of the can trunk section.

5. The method of manufacturing the product filled with hydrogen water according to claim 1,
wherein, in the process of filling the can container with the hydrogen water, except at the beginning of the filling with the hydrogen water, injection of the hydrogen water is performed in a submerged state in which an ejection port of a water injecting nozzle is disposed under a water surface of the hydrogen water already injected into the can container.

6. The method of manufacturing the product filled with hydrogen water according to claim 2,
wherein, in the process of filling the can container with the hydrogen water, except at the beginning of the filling with the hydrogen water, injection of the hydrogen water is performed in a submerged state in which an ejection port of a water injecting nozzle is disposed under a water surface of the hydrogen water already injected into the can container.

7. The method of manufacturing the product filled with hydrogen water according to claim 3,
wherein, in the process of filling the can container with the hydrogen water, except at the beginning of the filling with the hydrogen water, injection of the hydrogen water is performed in a submerged state in which an ejection port of a water injecting nozzle is disposed under a water surface of the hydrogen water already injected into the can container.

8. The method of manufacturing the product filled with hydrogen water according to claim 4,
wherein, in the process of filling the can container with the hydrogen water, except at the beginning of the filling with the hydrogen water, injection of the hydrogen water is performed in a submerged state in which an ejection port of a water injecting nozzle is disposed under a water surface of the hydrogen water already injected into the can container.

9. The method of manufacturing the product filled with hydrogen water according to claim 5,
wherein, in the process of filling the can container with the hydrogen water, filling of the hydrogen water is performed in a state in which a pressure in a filling pipeline is maintained within a predetermined range by a pressure adjustment mechanism installed in the filling pipeline upstream from the water injecting nozzle in a transferred direction of the hydrogen water.

10. The method of manufacturing the product filled with hydrogen water according to claim 6,
wherein, in the process of filling the can container with the hydrogen water, filling of the hydrogen water is performed in a state in which a pressure in a filling pipeline is maintained within a predetermined range by a pressure adjustment mechanism installed in the filling pipeline upstream from the water injecting nozzle in a transferred direction of the hydrogen water.

11. The method of manufacturing the product filled with hydrogen water according to claim 7,
wherein, in the process of filling the can container with the hydrogen water, filling of the hydrogen water is performed in a state in which a pressure in a filling pipeline is maintained within a predetermined range by a pressure adjustment mechanism installed in the filling pipeline upstream from the water injecting nozzle in a transferred direction of the hydrogen water.

12. The method of manufacturing the product filled with hydrogen water according to claim 8,
wherein, in the process of filling the can container with the hydrogen water, filling of the hydrogen water is performed in a state in which a pressure in a filling pipeline is maintained within a predetermined range by a pressure adjustment mechanism installed in the filling pipeline upstream from the water injecting nozzle in a transferred direction of the hydrogen water.
